(19) United States
(12) Patent Application Publication
(10) Pub. No.: US 2011/0137955 A1
(43) Pub. Date: Jun. 9, 2011

(54) APPARATUS AND METHOD FOR CREATING CAN DATA FILE FOR TEST

(75) Inventors: Dong-Myung SUL, Daejeon-si (KR); Byung-Yun LEE, Daejeon-si (KR); Byung-Sun LEE, Daejeon-si (KR)

(73) Assignee: Electronics and Telecommunications Research Institute, Daejeon-si (KR)

(21) Appl. No.: 12/873,861

(22) Filed: Sep. 1, 2010

(30) Foreign Application Priority Data
Dec. 8, 2009 (KR) 10-2009-0121367

(51) Int. Cl. G06F 17/30

(52) U.S. Cl. 707/803; 707/E17.044

(57) ABSTRACT

An apparatus and method of creating a Controller Area Network (CAN) data file for test are provided, in which a setting value of a travelling variable of a vehicle is received, a piece of standard CAN data for communication control between control parts of the vehicle is updated by reflecting the received setting value of the travelling variable, and associated CAN data is updated based on the updated standard CAN data. A test CAN data identical to CAN data which is created during actual driving of a vehicle without having to use expensive hardware equipment or software simulation, thereby facilitating a test process at a product development stage.

### CROSS-REFERENCE TO RELATED APPLICATION

This application claims the benefit under 35 U.S.C. §119(a) of Korean Patent Application No. 10-2009-0121367, filed on Dec. 8, 2009, the disclosure of which is incorporated by reference in its entirety for all purposes.

### BACKGROUND

1. Field

The following description relates to a data processing technology, more particularly, to an apparatus and method for creating a CAN data file for a test.

2. Description of the Related Art

A Controller Area Network (CAN) is a representative technology enabling communication within a vehicle, and can also be used in other areas in addition to vehicles. A CAN technology has been developed with the need for a BUS-structure network due to the increase of automotive electronics.

A High-Speed CAN provides data at a speed of 1 Mbps, thereby enabling the real time control of electronics. In addition, the High-Speed CAN provides superior error detection and error correction functions and simple interface and is cheaper to manufacture compared with other field bus technologies.

In general, the High-Speed CAN is used for an engine and transmission control system requiring a high speed of control. The main use of the High-Speed CAN is for an engine control, a gear box control, a steering wheel control, a pedal node control and a rear/front wheel control.

A Low-Speed CAN is normally used in a chassis system of a vehicle requiring relatively low speed of control. The main use of the Low-Speed CAN is for a lighting control, a seat back control, a left/right side door module control, a sun roof control, a wiper-wash control, an air back control and a climate control.

In a case where a test is performed using a conventional CAN data, expensive hardware test equipment needs to be used or a connection to an actual vehicle is required in practice to receive CAN data.

In addition, in this case, a test using a conventional CAN data needs to be performed by use of suitable data for a preset condition using software simulation equipment. In this case, a user has a difficulty in changing data, and in particular, when modifying a predetermined data, the user needs to modify individual pieces of data associated with the predetermined data. In this regard, it is difficult to perform testing at a product development stage.

### SUMMARY

In one aspect, there is provided an apparatus and method for creating a CAN data file, capable of easily creating CAN data for a test at a product development stage and automatically changing an associated CAN data value according to the variation of a standard CAN data value.

In one general aspect, there is provided a method of creating a Controller Area Network (CAN) data file for test. The method is as follows. A setting value of a travelling variable of a vehicle is received. A piece of standard CAN data for communication control between control parts of the vehicle is updated by reflecting the received setting value of the travelling variable. Associated CAN data is updated based on the updated standard CAN data.

The method further includes collecting a plurality of pieces of CAN data made during actual driving, and forming the collected CAN data into a database. The updating of the associated CAN data is performed based on information about the CAN data made during actual driving in a form of the database.

The collecting of the CAN data includes receiving a standard variation of a predetermined travelling variable, and monitoring a variation of a travelling variable relating to associated CAN data according to a change of the predetermined travelling variable, in a unit of the standard variation. The forming of the collected CAN data into a database includes forming a variation of the associated CAN data according to the change of the travelling variable into a database.

In another general aspect, there is provided an apparatus for creating a Controller Area Network (CAN) data file for test. The apparatus includes a vehicle communication unit and a CAN data update unit. The vehicle communication unit is configured to receive a plurality of pieces of CAN data for communication control from a control part. The CAN data update unit is configured to update a piece of standard CAN data of the received CAN data by reflecting an input setting value of a travelling variable and updates associated CAN data based on the updated standard CAN data.

The apparatus further includes a database unit and an information collection unit. The database unit is configured to store the plurality of pieces of CAN database. The information collecting unit is configured to collect CAN data, which is made during actual driving of a vehicle, through the vehicle communication unit and stores the collected CAN data in the database unit. The CAN data update unit updates the associated CAN data based on information stored in the database unit.

According to the present invention, a test CAN data identical to CAN data which is created during actual driving of a vehicle without having to use expensive hardware equipment or software simulation, thereby facilitating a test process at a product development stage.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a view showing a configuration of an example of an apparatus for creating CAN data file.

FIG. 2 is a view showing a control flow of an example of a method of creating CAN data file.

FIG. 3 is a view showing an example of a method of creating a database from associated CAN data.

FIG. 4 is a view showing an example of a method of modifying associated CAN data.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, detailed examples will be described with reference to accompanying drawings.

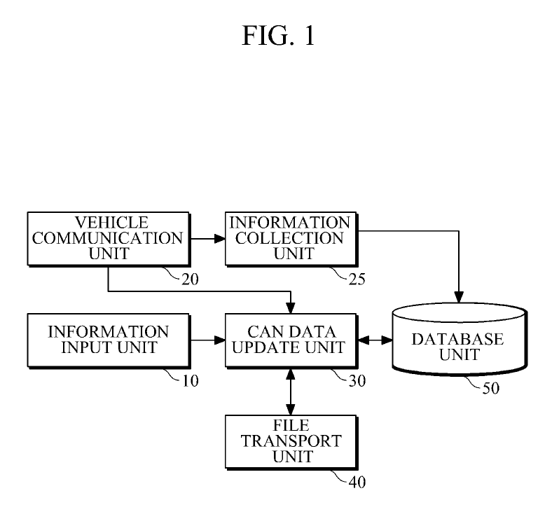

FIG. 1 is a view showing a configuration of an example of an apparatus for creating a CAN data file.

As shown in FIG. 1, an apparatus for creating a CAN data file includes an information input unit 10, a vehicle communication unit 20, a CAN data update unit 30, a file transport unit 40 and a database unit 50.

The information input unit 10 receives a manipulation signal of a user. In a state that information about an initial CAN data file is displayed on a screen, the information input unit 10 receives a update request for standard CAN data included in the CAN data file, identification information of standard CAN data needing to be modified and information about a travelling variable that is input when a user requires modification of the travelling variable.

The vehicle communication unit 20 receives CAN data for communication control from control parts of a vehicle. According to this example, such a control part may include a hardware manager control unit (HMCU), a battery management system (BMS), an engine control unit (ECU), an electronic throttle control (ETC), and a torque control unit (TCU). The vehicle communication unit 20 has a technical configuration for receiving data from such control parts.

The database unit 50 stores CAN data files including a plurality of pieces of CAN data. In one example, the database unit 50 stores information about the variation of travelling information such as revolutions per minutes (RPM) corresponding to an association CAN data, according to the change of travelling information, such as speed, corresponding to standard CAN data.

The information collection unit 25 collects CAN data made during actual driving of a vehicle through the vehicle communication unit 20, analyzes the collected CAN data and stores the analyzed CAN data in the database unit 50. In one example, the information collection unit 25 contains at least one of a frequency in use of the plurality of pieces of CAN data included in the CAN data file, information about travelling variables corresponding to the CAN data and information about a modifiable range of travelling variable. The information collection unit 25 creates a CAN data file by receiving a plurality of pieces of CAN data from the vehicle communication unit 20 and analyzing the information described above, and then stores the created CAN data file in the database unit 50.

The information collection unit 25 monitors a travelling variable corresponding to the standard CAN data and a travelling variable corresponding to associated CAN data relating to the standard CAN data and makes the travelling variables into a database.

For example, when a standard value changes from 50 to 100, the standard value may be divided by a predetermined unit of change 10. In this case, the range of change of an associated value corresponding to each unit of change of the standard value, that is, 10, is measured when the associated value changes 1000 to 3000, and the range of change is reflected in the variation of other associated values.

For example, the database unit stores data as follows.

| Change of Speed | Change of RPM | Variation |
|---|---|---|
| 50 → 60 | 1000 → 1200 | 200 |
| 60 → 70 | 1200 → 1500 | 300 |
| 70 → 80 | 1500 → 2000 | 500 |
| 80 → 90 | 2000 → 2400 | 400 |
| 90 → 100 | 2400 → 3000 | 600 |

The CAN data update unit 30 updates information about CAN data stored in the database unit 50. In one example, the CAN data update unit 30 updates standard CAN data among a plurality of pieces of received CAN data based on a setting value of a travelling variable. Then, the CAN data update unit 30 updates associated CAN data based on the updated CAN data. For example, when the setting value is a speed value which is set by a user, the standard CAN data may be speed related data and the associated CAN data may be RPM related data.

The CAN data update unit 30 determines a modification value of the associated CAN data by use of a correlation between a variation of the standard CAN data and a variation of the associated CAN data, and updates the associated CAN data using the determined modification value. The CAN data update unit 30 recognizes identification information of the associated CAN data, and determines whether the associated CAN data needs to be modified, by use of the recognized identification information. Then, the CAN data update unit 30 updates the associated CAN data needing to be modified, based on the change of the standard CAN data.

The CAN data update unit 30 determines the range of change of a CAN data value associated with a main CAN data value according to the change of the main CAN data value, based on the information stored in the database unit 50. In this manner, a change value of the associated CAN data according to the change of the main CAN data is estimated. For example, the RPM of an engine, the battery voltage, the temperature of cooling water according to the change of travelling speed of a vehicle is determined.

As described above, when a single piece of CAN data is modified by use of information of the database unit 50, another piece of CAN data associated with the modified CAN data is automatically modified in a manner to apply the range of change of the associated CAN data to the associated CAN data. The associated CAN data may be preset by a user. In this regard, if a user wants to perform a test at a desired speed and modifies standard CAN data to correspond to the desired speed, another setting values associated with the modified standard CAN data are also automatically modified. That is, the test environment is more easily configured at a product development stage of vehicle related equipment, such as a black box and a navigation system.

The file transport unit 40 transports a test CAN data file including the updated standard CAN data and the updated associated CAN data to test equipment.

The variation value of the associated CAN data may be used by only extracting from the database unit 50 or may be used in a manner that a user specifies a calibration coefficient. In this manner, the intention of a user is maximally reflected in a test.

As described above, a variation of an associated value according to the change of a standard value is measured, and the variation is reflected in changing following associated values, thus the change of associated values is automatically achieved and data similar to data made during an actual driving of a vehicle is obtained.

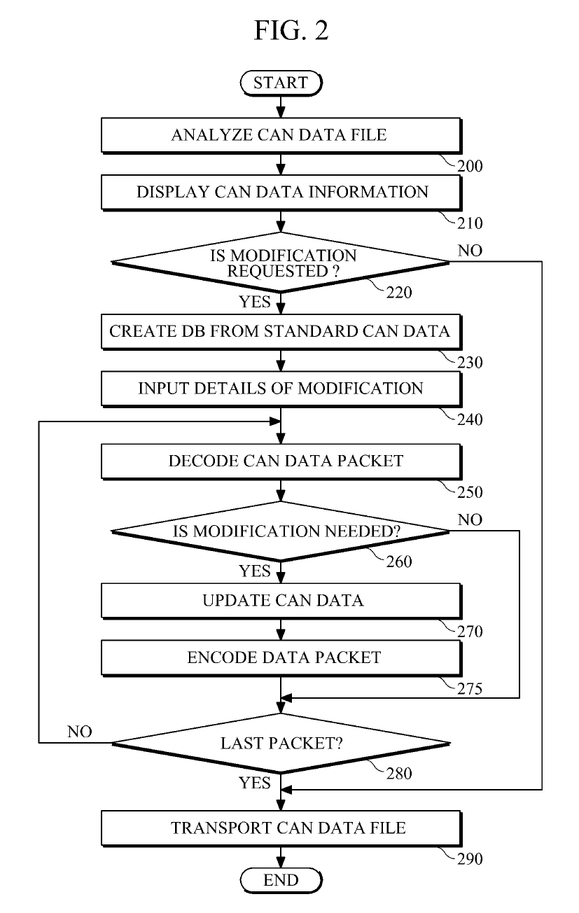

FIG. 2 is a view showing a control flow of an example of a method of creating CAN data file.

Information about a plurality of pieces of CAN data included in a CAN data file is analyzed (200). The CAN data file includes a plurality of pieces of CAN data that are received from different control parts of a vehicle. After the analysis on the CAN data file, a result of the analysis is displayed on a screen (210). In detail, brief information about the CAN data included in the CAN data file in execution is analyzed. For example, a frequency in use of each piece of CAN data included in the CAN data file in execution, main data values of collected CAN data, such as minimum value and maximum value of collected CAN data, and information about transport time of the entire data are displayed to a user.

Standard CAN data values are provided to a user through a screen, and a result denoting whether to modify CAN data and a modification value are input (220). The modification value is input in a way that a user increases/decreases an original data value. In addition, identification information of associated CAN data needing to be modified is also input. If modification is not needed, the CAN data is transported as it is.

If modification is needed, a user makes a CAN data file into a database to determine the range of change of preset standard data and associated data (230). For example, a user may make a setting such that RPM values are automatically modified from increase and decrease of speed values of a vehicle by a preset value. In addition, the change of RPM with the change of speed value is also integrated into the database such that the change of RPM is automatically reflected when changing following RPM values. Accordingly, if the speed related CAN data is standard CAN data, RPM related CAN data may be set as associated CAN data.

After that, individual pieces of information about a time when a predetermined piece of CAN data is modified and transported, standard CAN data to be modified and associated CAN data associated with the standard CAN data are input by a user (240). If the CAN data to be modified is outside a predetermined modifiable range, an estimate value on the change of the CAN data is displayed and the estimate value may be compensated by a user. Since the estimate value based on the CAN data has a low reliability, the CAN data is compensated based on data retained by a user, thereby increasing the reliability of the estimate value.

After the input about the modified data is completed, it is determined whether the input is regarding a modification request for a single piece of CAN data or an automatic modification corresponding to both of a single piece of CAN data and other associated CAN data.

After a user's setting is completed, a CAN data file generating process is performed according to a request. In detail, individual pieces of CAN data information are decoded (250), and CAN data IDs are extracted to identify CAN data needing to be modified. In the case of data needing to be modified (260), the values previously integrated into the database are reflected to the CAN data needing to be modified, so that the CAN data is modified (270). After the modification is completed, the CAN data information is encoded (275). If the modification is completed on all pieces of CAN data packet included in the CAN data file (280), the encoded CAN data file is transported to equipment needing to be subject to a test (290).

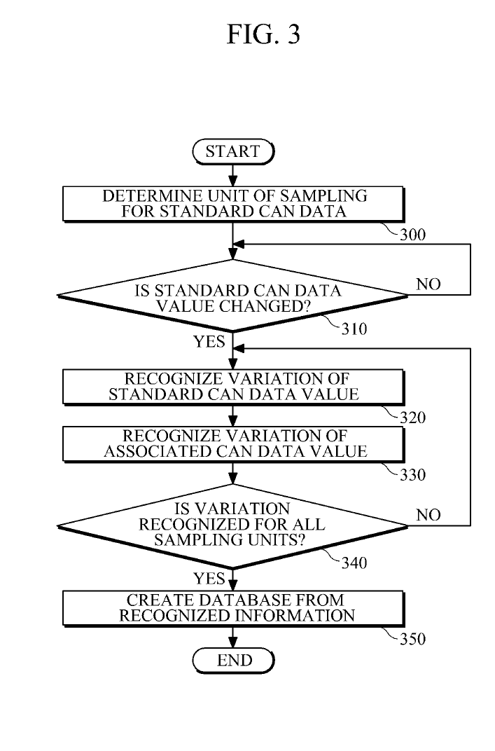

FIG. 3 is a view showing an example of a method of creating a database from associated CAN data.

A method of creating a database from CAN data is as follows. First, each piece of information about standard CAN data and associated CAN data which is to be modified with the standard CAN data modification is identified. Then, a database is created based on the identified information.

In this case, a unit of sampling is determined for standard data values, based on the minimum/maximum permissible range for a message value of the standard CAN data (300). For example, in the case of speed information of a vehicle, the range of sampling is about 0 to 255, and the unit of sampling is 1.

If CAN data is input from a vehicle, the CAN data is decoded and checked if the data represents standard CAN data or associated CAN data. If the CAN data is a standard DATA, a variation of the standard CAN data from an original standard CAN data is recognized (310 and 320). The variation of associated data according to the variation of the standard CAN data is recognized (330).

For example, in a case of speed of a vehicle, the unit of sampling may beset to 1 and an associated value may be RPM. If the speed increases by 1 or more, a changed RPM value and the variation of the RPM are stored. If the speed does not increase or increases by 1 or less, the associated CAN data, that is, the variation of the RPM is not monitored.

After completing with the analysis of all of CAN data information, it is checked whether an analysis has been completed on each associated data value for respective sampling values of the standard CAN data (340). If the associated CAN data has not been monitored for all of the sampling units, the range of change of associated CAN data for the corresponding sampling unit is calculated based on associated CAN data values each corresponding to the previous sampling unit and the following sampling unit, and the calculated range of change of the associated CAN data is reflected to estimate the variation of the associated CAN data (350).

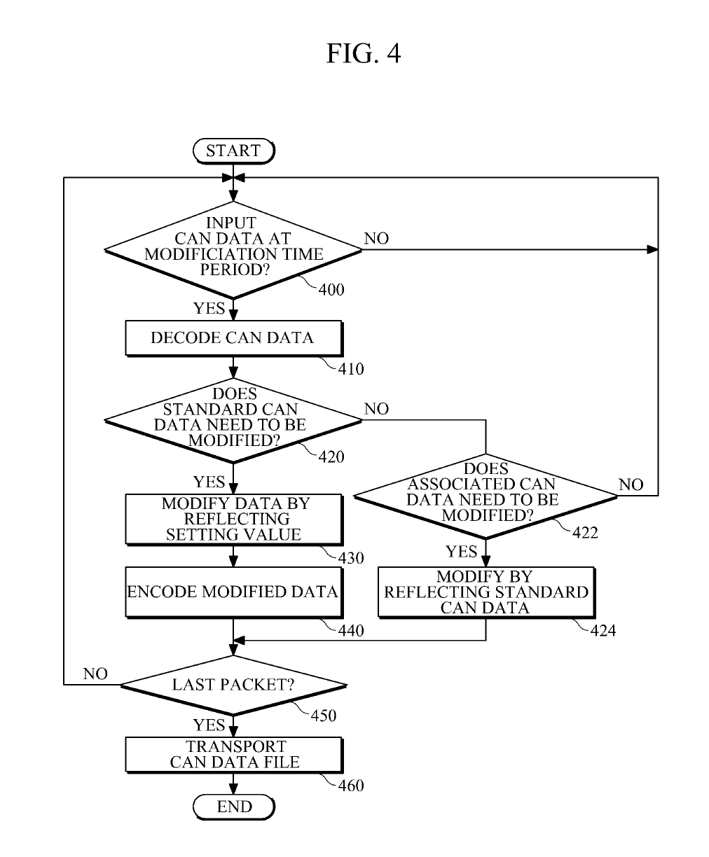

FIG. 4 is a view showing an example of a method of modifying associated CAN data.

First, it is determined that a predetermined CAN data corresponds to which modification time period, by use of information about time the predetermined CAN data occur (400). The modification time period may represent time information that is set by a user to perform a test on equipment. That is, CAN data occurring during a predetermined period of time may be set to be used as data for a test.

CAN data corresponding to the modification time period is decoded and CAN ID information is extracted (410). After that, it is determined if corresponding information is standard data needing to be modified or associated data (420). If the corresponding CAN data is the standard data, a user's setting value is added/subtracted to/from the standard data (430) and then the standard data is encoded (440). If the corresponding CAN data is the associated data, an associated data value corresponding to a standard data value is fetched from a previously constructed database and reflected in the associated data, and then the associated data is encoded (424).

After all CAN data has been completed with the modification, a CAN data file including the standard CAN data and the associated CAN data is transported to test equipment (460).

The disclosure can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion

Also, functional programs, codes, and code segments for accomplishing the present invention can be easily construed by programmers skilled in the art to which the present invention pertains. A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of creating a Controller Area Network (CAN) data file for test, the method comprising:
receiving a setting value of a travelling variable of a vehicle;
updating a piece of standard CAN data for communication control between control parts of the vehicle by reflecting the received setting value of the travelling variable; and
updating associated CAN data based on the updated standard CAN data.

2. The method of claim 1, further comprising:
collecting a plurality of pieces of CAN data made during actual driving; and
forming the collected CAN data into a database,
wherein the updating of the associated CAN data is performed based on information about the CAN data made during actual driving in a form of the database.

3. The method of claim 2, wherein the collecting of the CAN data comprises:
receiving a standard variation of a predetermined travelling variable; and
monitoring a variation of a travelling variable relating to associated CAN data according to a change of the predetermined travelling variable, in a unit of the standard variation, and wherein
the forming of the collected CAN data into a database comprises:
forming a variation of the associated CAN data according to the change of the travelling variable into a database.

4. The method of claim 3, wherein in the updating of the associated CAN data, a modification value of the associated CAN data is determined by use of a correlation between a variation of the standard CAN data and a variation of the associated CAN data, and the associated CAN data is updated using the determined modification value.

5. The method of claim 4, wherein the variation of the standard CAN data is the variation of the predetermined travelling variable, and the variation of the associated CAN data is the variation of the travelling variable relating to the associated CAN data.

6. The method of claim 1, further comprising transporting the CAN data file for test including the updated standard CAN data and the updated associated data to test equipment.

7. The method of claim 1, further comprising:
displaying information about an initial CAN data file on a screen;
receiving a request for updating the standard CAN data included in the CAN data file for test; and
receiving identification information of the associated CAN data which is updated with the standard CAN data update.

8. The method of claim 7, wherein the initial CAN data file information includes at least one of a frequency in use of the plurality of pieces of CAN data included in the CAN data file, information about travelling variables corresponding to the CAN data and information about a modifiable range of a travelling variable.

9. The method of claim 7, wherein the updating of the associated CAN data comprises:
recognizing the identification information of the associated CAN data;
determining whether the associated CAN data needs to be modified, by use of the identification information; and
updating the associated CAN data based on the updated standard CAN data, according to a result of the determination.

10. An apparatus for creating a Controller Area Network (CAN) data file for test, the apparatus comprising:
a vehicle communication unit configured to receive a plurality of pieces of CAN data for communication control from a control part; and
a CAN data update unit configured to update a piece of standard CAN data of the received CAN data by reflecting an input setting value of a travelling variable and updates associated CAN data based on the updated standard CAN data.

11. The apparatus of claim 10, further comprising:
a database unit configured to store the plurality of pieces of CAN database; and
an information collecting unit configured to collect CAN data, which is made during actual driving of a vehicle, through the vehicle communication unit and stores the collected CAN data in the database unit, wherein
the CAN data update unit updates the associated CAN data based on information stored in the database unit.

12. The apparatus of claim 11, wherein the information collecting unit is configured to monitor a variation of a travelling variable according to a change of a predetermined travelling variable in a unit of a standard variation of the predetermined travelling variable, and to form the variation of the travelling variable according to the change of the predetermined travelling variable into a database.

13. The apparatus of claim 12, wherein the CAN data update unit determines a modification value of the associated CAN data by use of a correlation between a variation of the standard CAN data and a variation of the associated CAN data, and updates the associated CAN data using the determined modification value.

14. The apparatus of claim 10, further comprising a file transport unit configured to transport the CAN data file for test including the updated standard CAN data and the updated associated data to test equipment.

15. The apparatus of claim 10, further comprising an information input unit configured to display information about an initial CAN data file on a screen to receive a request for updating the standard CAN data included in the CAN data file for test, and identification information of the associated CAN data which is updated with the standard CAN data update.

16. The apparatus of claim 15, wherein the initial CAN data file information includes at least one of a frequency in use of the plurality of pieces of CAN data included in the CAN data file, information about a travelling variable corresponding to each CAN data and information about a range of a modifiable travelling variable.

17. The apparatus of claim 15, wherein the CAN data update unit is configured to recognize the identification information of the associated CAN data, determine whether the associated CAN data needs to be modified, by use of the identification information, and update the associated CAN data needing to be modified.
